(19) United States
(12) Patent Application Publication
(10) Pub. No.: US 2016/0040612 A1
(43) Pub. Date: Feb. 11, 2016

(54) FUEL CUTOFF SYSTEM FOR LIQUEFIED PETROLEUM INJECTION VEHICLE AND CONTROL METHOD THEREOF

(71) Applicants: HYUNDAI MOTOR COMPANY, Seoul (KR); Kia Motors Corporation, Seoul (KR)

(72) Inventors: Hyun KIM, Hwaseong-si (KR); Do Geun JUNG, Suwon-si (KR)

(21) Appl. No.: 14/558,552

(22) Filed: Dec. 2, 2014

(30) Foreign Application Priority Data
Aug. 11, 2014 (KR) 10-2014-0103466

(51) Int. Cl. F02D 41/00; F02M 21/02

(52) U.S. Cl. CPC F02D 41/0027; F02M 21/0212

(57) ABSTRACT

A fuel cutoff system for a liquefied petroleum injection (LPI) vehicle includes a bombe that stores liquefied petroleum gas (LPG) fuel. At least one injector is connected to a fuel pump, which is disposed in the bombe, through a fuel supply line, and the at least one injector is provided in an engine to supply the LPG fuel fed through the fuel supply line to the engine. A fuel return line interconnects the engine and the bombe, separately from the fuel supply line, through which the LPG fuel returns to the bombe from the engine. At least one fuel cutoff valve is provided on the fuel supply line. The at least one fuel cutoff valve is electrically connected to an ignition key and activated by an ignition power supplied depending on whether the ignition key is in an On or Off position.

### CROSS-REFERENCE TO RELATED APPLICATION

The present application claims the benefit of priority to Korean Patent Application Number 10-2014-0103466 filed on Aug. 11, 2014, the entire contents of which application are incorporated herein for all purposes by this reference.

### TECHNICAL FIELD

The present disclosure relates to a fuel cutoff system for a liquefied petroleum injection (LPI) vehicle and a control method thereof, and more particularly, to a fuel cutoff system for an LPI vehicle which quickly cuts off liquefied petroleum gas (LPG) fuel supply in an emergency situation while the vehicle is starting up or running, and a control method thereof.

### BACKGROUND

In general, a liquefied petroleum injection (LPI) engine (LPG liquid fuel injection device) is a new technology such as mono-fuel system in which a fuel pump is installed in a bombe. An engine runs by injecting liquefied fuel for each cylinder via an injector by liquefying LPG fuel at high pressure (5 to 15 bar) by the fuel pump, unlike a mechanical LPG fuel system which depends on a bombe pressure.

Since the LPI engine injects liquefied fuel, a high-pressure injector, the fuel pump, a fuel supply line, an electronic control unit (ECU) exclusively for LPI, a regulator unit regulating fuel pressure, and the like can replace components such as a vaporizer, a mixer, and the like.

The ECU of the LPI engine determines a LPI engine state by receiving input signals from various sensors and controls the fuel pump, the high-pressure injector, and an ignition coil for an optimal air-fuel ratio and improvement of engine performance.

In addition, the liquefied fuel is supplied to the engine by controlling the fuel pump according to a fuel amount required in the LPI engine, and an LPI injector sequentially injects fuel for each cylinder to thereby implement the optimal air-fuel ratio.

Such an LPI vehicle employs a vehicle cutoff system that cuts off the supply of LPG fuel in an emergency situation in order to meet the safety standards.

A conventional fuel cutoff system for the LPI vehicle has an LPG fuel switch inside the vehicle and is configured to cut off the supply of LPG fuel in an emergency situation by a user operation.

In the above-stated conventional fuel cutoff system for the LPI vehicle, however, the LPG fuel switch needs to be provided inside the vehicle, thus increasing the number of operating switches for mounting the LPG fuel switch inside the vehicle and reducing the user convenience.

Moreover, in an emergency situation, the driver may accidentally forget to activate the LPG fuel switch in panic, making it difficult to quickly cut off the supply of LPG fuel.

The information disclosed in this Background section is only for enhancement of understanding of the general background of the disclosure and should not be taken as an acknowledgement or any form of suggestion that this information forms the prior art already known to a person skilled in the art.

### SUMMARY

The present disclosure has been made in an effort to provide a fuel cutoff system for a liquefied petroleum injection (LPI) vehicle which quickly cuts off the supply of liquefied petroleum gas (LPG) fuel simply by manually shutting of the vehicle in an emergency situation while the vehicle is running to reduce cost, decrease the number of in-vehicle operating switches, and improve driver's convenience by removing an LPG fuel switch while satisfying the safety laws.

According to an exemplary embodiment of the present inventive concept, a fuel cutoff system for an LPI vehicle includes a bombe that stores liquefied petroleum gas (LPG) fuel. At least one injector is connected to a fuel pump, disposed in the bombe through a fuel supply line, and provided in an engine to supply the LPG fuel fed through the fuel supply line to the engine. A fuel return line interconnects the engine and the bombe, separately from the fuel supply line, through which the LPG fuel moves to return to the bombe from the engine. At least one fuel cutoff valve is provided on the fuel supply line. The at least one fuel cutoff valve is electrically connected to an ignition key and activated by an ignition power supplied depending on whether the ignition key is in an On or Off position to selectively cut off the supply of the LPG fuel to the at least one injector from the bombe.

The bombe and the engine may be respectively equipped with the one fuel cutoff valve on the fuel supply line.

When the ignition key is in the On position, the at least one fuel cutoff valve may be opened to supply the LPG fuel through the fuel supply line by receiving the ignition power. When the ignition key is in the Off position, the at least one fuel cutoff valve may be closed to cut off the supply of the LPG fuel through the fuel supply line because the supply of the ignition power is stopped.

According to another exemplary embodiment of the present inventive concept, a control method of a fuel cutoff system for an LPI vehicle is provided, which cuts off supply of an LPG fuel fed to an engine from a bombe through an injector when an ignition off condition or an emergency fuel cutoff condition occurs in the LPI vehicle. The control method comprising: (A) determining whether an ignition key is in an On position and selectively activating a fuel cutoff valve mounted on a fuel supply line that connects the bombe and the engine; and (B) determining whether the ignition key is turned off while the fuel cutoff valve is opened and keeping the fuel cutoff valve opened or closing the fuel cutoff valve.

The step (A) may include determining whether the ignition key is in the On position. If the ignition key is in the On position, the fuel cutoff valve is opened to supply the LPG fuel stored in the bombe to the fuel supply line. If the ignition key is not in the On position, the fuel cutoff valve is closed to cut off the supply of the LPG fuel to the fuel supply line.

The step (B) may include determining whether the ignition key is turned off while the fuel cutoff valve is opened. If the ignition key is not turned off, the fuel cutoff valve is opened to continuously supply the LPG fuel through the fuel supply line. If the ignition key is turned off, the fuel cutoff valve is closed to cut off the supply of the LPG fuel to the fuel supply line.

The step of determining whether the ignition key is turned off may be performed under an emergency fuel cutoff condition involving fuel leakage or fire or under a normal ignition off condition triggered when the vehicle stops driving.

The fuel cutoff valve may be electrically connected to the ignition key and activated by an ignition power supplied selectively depending on whether the ignition key is in the On position or an Off position.

### BRIEF DESCRIPTION OF THE DRAWINGS

FIG. 1 is a configuration diagram of a fuel cutoff system for a liquefied petroleum injection (LPI) vehicle according to an exemplary embodiment of the present inventive concept.

FIG. 2 is a control flowchart for explaining a control method of a fuel cutoff system for an LPI vehicle according to an exemplary embodiment of the present inventive concept.

### DETAILED DESCRIPTION

An exemplary embodiment of the present inventive concept will hereinafter be described in detail with reference to the accompanying drawings.

Prior to this, the exemplary embodiment described in the specification and the constructions illustrated in the drawings correspond to only exemplary embodiment, but do not represent all of the technical spirit of the present inventive concept. Accordingly, it should be understood that various equivalents and modifications can substitute them at the time of filing the present disclosure.

A part irrelevant to the description will be omitted to clearly describe the present disclosure, and the same or similar elements will be designated by the same reference numerals throughout the specification.

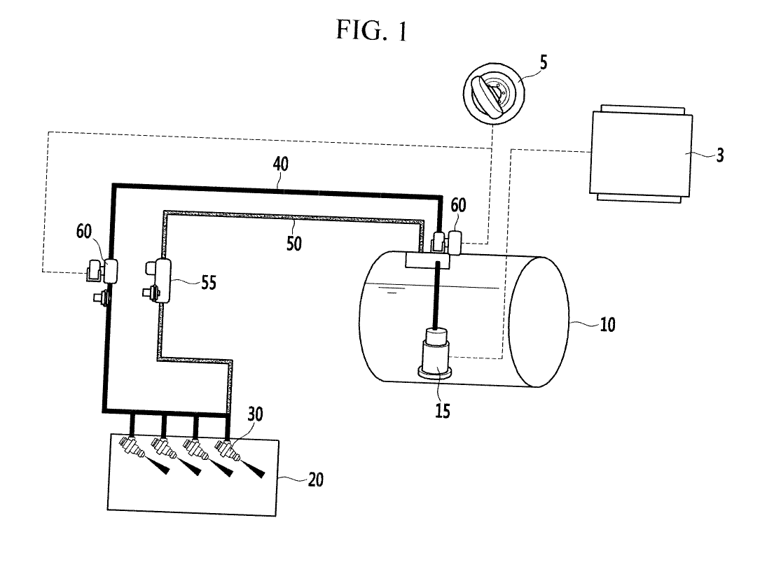

FIG. 1 is a configuration diagram of a fuel cutoff system for an LPI vehicle according to an exemplary embodiment of the present inventive concept.

Referring to the drawing, the fuel cutoff system for an LPI vehicle according to an exemplary embodiment of the present inventive concept quickly cuts off LPG fuel supply simply by manually turning off the vehicle in an emergency situation while the vehicle is running to reduce cost, decrease the number of in-vehicle operating switches, and improve driver's convenience by removing an LPG fuel switch while satisfying the safety regulations.

The fuel cutoff system for the LPI vehicle according to the exemplary embodiment of the present inventive concept includes a bombe 10, an injector 30, a fuel return line 50, and a fuel cutoff valve 60.

First, the bombe 10 has LPG fuel stored therein, and is disposed inside a trunk of the vehicle.

In the present disclosure, the injector 30 is connected through a fuel supply line 40 to a fuel pump 15 that is disposed in the bombe 10 and activated by a control signal from a vehicle electronic control unit (ECU) 3.

The injector 30 is provided for each cylinder in an engine 20, and supplies the LPG fuel fed through the fuel supply line 40 to the engine 20.

The fuel return line 50 interconnects the engine 20 and the bombe 10, separately from the fuel supply line 40, through which the LPG fuel returns to the bombe 10 from the engine 20. The fuel return line 50 may be equipped with a pressure regulator 55 for regulating the pressure of the LPG fuel that is not unburnt in the engine 20 and returns to the bombe 10.

Moreover, at least one fuel cutoff valve 60 is provided on the fuel supply line 40.

The fuel cutoff valve 60 is electrically connected to an ignition key 5, and activated by ignition power supplied depending on whether the ignition key 5 is in the On or Off position to selectively cut off the supply of the LPG fuel to the engine 20 from the bombe 10 through the injector 30.

The bombe 10 and the engine 20 may individually have one fuel cutoff valve 60 on the fuel supply line 40.

When the ignition key 5 is in the On position, the fuel cutoff valve 60 opens and supplies the LPG fuel through the fuel supply line 40 by the ignition power.

On the contrary, when the ignition key 5 is in the Off position, the fuel cutoff valve 60 closes and cuts off the supply of the LPG fuel through the fuel supply line 60 as the supply of the ignition power is stopped.

That is, the fuel cutoff system for the LPI vehicle according to the exemplary embodiment of the present inventive concept is electrically connected to the ignition key 5 of the fuel cutoff valve 60 and opened and closed depending on whether the ignition key 5 is in the On or Off position to selectively open and close the fuel supply line 60.

Accordingly, the LIP vehicle adopting the fuel cutoff system according to the present disclosure is able to quickly cut off the supply of LPG fuel simply by operating the ignition key, rather than operating an LPG fuel switch, under an emergency fuel cutoff condition triggered by fuel leakage or fire, or under a normal ignition off condition triggered when the vehicle is stopped.

Hereinafter, a control method of a fuel cutoff system for an LPI vehicle according to an exemplary embodiment of the present inventive concept will be described in detail.

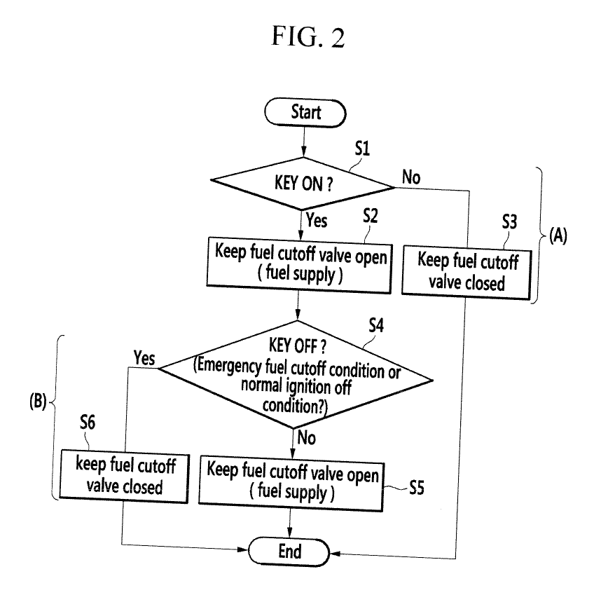

FIG. 2 is a control flowchart for explaining a control method of a fuel cutoff system for an LPI vehicle according to an exemplary embodiment of the present inventive concept.

Referring to FIG. 2, the control method of a fuel cutoff system for the LPI vehicle according to the exemplary embodiment of the present inventive concept cuts off the supply of LPG fuel fed to the engine 20 from the bombe 10 through the injector 30 under an ignition off condition or emergency fuel cutoff condition in the LPI vehicle. The control method may include: (A) determining whether the ignition key 5 is in the On position and selectively activating the fuel cutoff valve 60 mounted on the fuel supply line 40 that connects the bombe 10 and the engine 20; and (B) determining whether the ignition key 5 is turned off while the fuel cutoff valve 60 opens and keeping the fuel cutoff valve 60 opened or closing the fuel cutoff valve 60.

First, whether the ignition key 5 is in the On position is determined (S1). If the ignition key 5 is in the On position, the fuel cutoff valve 60 opens and supplies the LPG fuel stored in the bombe 10 to the fuel supply line 40 (S2).

On the other hand, if the ignition key 5 is not in the On position, the fuel cutoff valve 60 is kept closed to cut off the supply of the LPG fuel stored in the bombe 10 to the fuel supply line 60 (S3).

Then, whether the ignition key 5 is turned off is determined while the fuel cutoff valve 60 is opened (S4).

Whether the ignition key 5 is turned off may be determined at step S4 under an emergency fuel cutoff condition such as fuel leakage or fire or under a normal ignition off condition triggered when the vehicle is stopped.

The emergency fuel cutoff condition is well-known to those skilled ordinarily skilled in the art, so the detailed description thereof will be omitted the.

Here, the fuel cutoff valve 60 is electrically connected to the ignition key 5, and activated by ignition power supplied selectively depending on whether the ignition key is in the On or Off position.

In the present disclosure, in the step S4 of determining whether the ignition key is turned off, if the ignition key 5 is not turned off, the fuel cutoff valve 60 is opened to continuously supply the LPG fuel through the fuel supply line 40 (S5).

On the contrary, if the aforementioned emergency fuel cutoff condition or the normal ignition off condition is determined and the ignition key is turned off, the fuel cutoff valve 60 in the open state is closed to cut off the supply of the LPG fuel to the fuel supply line 60 (S6).

As described above, in the control method of the fuel cutoff system for the LPI vehicle according to the exemplary embodiment of the present inventive concept, the fuel cutoff valve 60 opens using the ignition power supplied to the vehicle when the ignition key 5 is in the On position, so that LPG fuel is fed to the engine to properly start the vehicle or keep the vehicle running.

In contrast, when the emergency fuel cutoff condition or the normal ignition off condition occurs, the ignition key 5 is turned off to quickly cut off the supply of the LPG fuel to the engine 20.

That is, the present disclosure quickly cuts off the supply of LPG fuel to the engine 20 depending on whether the ignition key 5 is turned off or not, and therefore prevents serious damage that may occur if a conventional fuel cutoff system employing an LPG switch if the driver forgets to activate the LPG switch in an emergency situation, such as vehicle fire, fuel leakage, or other accidents.

Accordingly, the above-described fuel cutoff system for the LPI vehicle and control method thereof according to the exemplary embodiments of the present inventive concept quickly cuts off the supply of LPG fuel simply by the driver's key operation in an emergency situation while the vehicle is starting up or running to reduce cost, decrease the number of in-vehicle operating switches, and improve driver's convenience by removing an LPG fuel switch while satisfying the safety laws.

The fuel cutoff system and control method thereof according to the exemplary embodiments of the present inventive concept can improve driver's convenience reducing the number of in-vehicle operating switches, and at the same time operates in conjunction with the On or Off position of the ignition key so as to cut off the supply of LPG fuel more quickly in an emergency situation such as fuel leakage or fire, thereby improving reliability of fuel cutoff operations.

As described above, the present inventive concept has been described in relation to specific embodiments of the present inventive concept, but this is only for illustration and the present inventive concept is not limited thereto. Embodiments described may be changed or modified by those skilled in the art to which the present inventive concept pertains without departing from the scope of the present inventive concept, and various alterations and modifications are possible within the technical spirit of the present inventive concept and the equivalent scope of the claims which will be described below.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A fuel cutoff system for a liquefied petroleum injection (LPI) vehicle comprising:
a bombe that stores liquefied petroleum gas (LPG) fuel;
at least one injector connected to a fuel pump, which is disposed in the bombe, through a fuel supply line, the at least one injector provided in an engine to supply the LPG fuel fed through the fuel supply line to the engine;
a fuel return line interconnecting the engine and the bombe, separately from the fuel supply line, through which the LPG fuel returns to the bombe from the engine; and
at least one fuel cutoff valve provided on the fuel supply line,
wherein the at least one fuel cutoff valve is electrically connected to an ignition key and activated by an ignition power supplied depending on whether the ignition key is in an On or Off position to selectively cut off the supply of the LPG fuel to the at least one injector from the bombe.

2. The fuel cutoff system of claim 1, wherein the bombe and the engine respectively have the one fuel cutoff valve on the fuel supply line.

3. The fuel cutoff system of claim 1, wherein when the ignition key is in the On position, the at least one fuel cutoff valve opens and supplies the LPG fuel through the fuel supply line by the ignition power, and when the ignition key is in the Off position, the at least one fuel cutoff valve closes and cuts off the supply of the LPG fuel through the fuel supply line because the supply of the ignition power is stopped.

4. A control method of a fuel cutoff system for an LPI vehicle, which cuts off supply of an LPG fuel fed to an engine from a bombe through an injector under an ignition off condition or an emergency fuel cutoff condition in the LPI vehicle, the control method comprising:
(A) determining whether an ignition key is in an On position and selectively activating a fuel cutoff valve mounted on a fuel supply line that connects the bombe and the engine; and
(B) determining whether the ignition key is turned off while the fuel cutoff valve is opened and keeping the fuel cutoff valve open or closing the fuel cutoff valve.

5. The control method of claim 4, wherein the step (A) comprises:
determining whether the ignition key is in the On position;
if the ignition key is in the On position, opening the fuel cutoff valve to supply the LPG fuel stored in the bombe to the fuel supply line; and
if the ignition key is not in the On position, keeping the fuel cutoff valve closed to cut off the supply of the LPG fuel to the fuel supply line.

6. The control method of claim 4, wherein the step (B) comprises:
determining whether the ignition key is turned off while the fuel cutoff valve is opened;
if the ignition key is not turned off, keeping the fuel cutoff valve opened to continuously supply the LPG fuel through the fuel supply line; and
if the ignition key is turned off, closing the fuel cutoff valve to cut off the supply of the LPG fuel to the fuel supply line.

7. The control method of claim 6, wherein the step of determining whether the ignition key is turned off is performed under an emergency fuel cutoff condition involving fuel leakage or fire or under a normal ignition off condition triggered when the vehicle stops driving.

8. The control method of claim 5, wherein the fuel cutoff valve is electrically connected to the ignition key and activated by an ignition power supplied selectively depending on whether the ignition key is in the On position or an Off position.

9. The control method of claim 6, wherein the fuel cutoff valve is electrically connected to the ignition key and activated by an ignition power supplied selectively depending on whether the ignition key is in the On position or an Off position.
